(19) United States
(12) Patent Application Publication
(10) Pub. No.: US 2013/0020863 A1
(43) Pub. Date: Jan. 24, 2013

(54) POWER SUPPLY SYSTEM AND VEHICLE EQUIPPED WITH POWER SUPPLY SYSTEM

(71) Applicants: Yoshinobu Sugiyama, Toyota-shi (JP); Wanleng Ang, Okazaki-shi (JP)

(72) Inventors: Yoshinobu Sugiyama, Toyota-shi (JP); Wanleng Ang, Okazaki-shi (JP)

(73) Assignee: Toyota Jidosha Kabushiki Kaisha, Toyota-shi, Aichi-ken (JP)

(21) Appl. No.: 13/521,613

(22) PCT Filed: Apr. 7, 2011
(86) PCT No.: PCT/IB2011/000757

§ 371 Date: Jul. 11, 2012

(30) Foreign Application Priority Data
Apr. 14, 2010 (JP) 2010-093249

(51) Int. Cl. B60R 16/02; H02J 7/00

(52) U.S. Cl. 307/9.1; 320/134

(57) ABSTRACT

A power supply system or a vehicle includes: a first storage device; a charging device charging the first storage device with external power; a second storage device supplying an auxiliary load with a voltage lower than an output voltage of the first storage device; a first converter stepping down a voltage of power from the first storage device and supplying the auxiliary load and the second storage device with a voltage; a first controller controlling the charging device; a second converter smaller in capacity than the first converter, supplying the first controller with a voltage and charging the second storage device with the external power; and a second controller, when the external power is charged, controlling the first and second converters to selectively operate any one of the first and second converters based on a state of charge of the second storage device and a state of the auxiliary load.

### BACKGROUND OF THE INVENTION

1. Field of the Invention

The invention relates to a power supply system and a vehicle equipped with the power supply system and, more particularly, to charging control for charging an electrical storage device equipped for a vehicle with electric power supplied from an external power supply.

2. Description of the Related Art

In recent years, as an environmentally friendly vehicle, an electromotive vehicle that is equipped with an electrical storage device (for example, a secondary battery, a capacitor, or the like) and that is propelled by driving force generated from electric power stored in the electrical storage device receives attention. The electromotive vehicle, for example, includes an electric vehicle, a hybrid vehicle, a fuel cell vehicle, and the like. Then, there is proposed a technique for charging electrical storage devices equipped for these electromotive vehicles by a commercial power supply having a high power generation efficiency.

There is known a hybrid vehicle that is able to charge an in-vehicle electrical storage device from a power supply (hereinafter, also simply referred to as “external power supply”) outside the vehicle (hereinafter, also simply referred to as “external charging”) as in the case of an electric vehicle. For example, there is known a so-called plug-in hybrid vehicle that is able to charge an electrical storage device using a power supply of an ordinary household in such a manner that a power supply wall outlet installed in a house is connected to a charging inlet provided for a vehicle via a charging cable. By so doing, it may be expected to improve the fuel consumption efficiency of the hybrid vehicle.

Japanese Patent Application Publication No. 2009-027774 (JP-A-2009-027774) describes a technique for, in a vehicle equipped with a battery that allows external charging, continuously operating a DC/DC converter, which is used to step down the voltage of the battery to drive auxiliary loads and charge an auxiliary battery, during operation of the vehicle and intermittently operating the DC/DC converter during external charging.

With the technique described in JP-A-2009-027774, in comparison with a case where the DC/DC converter is constantly driven during external charging, a loss at the time of power conversion carried out by the DC/DC converter may be reduced through intermittent operation, so it is possible to improve the charging efficiency.

Such a DC/DC converter not only charges the auxiliary battery but also drives all the auxiliary loads of the vehicle during operation of the vehicle, so a relatively high-power DC/DC converter is employed.

However, during external charging, a smaller number of auxiliary loads are driven as compared with that during operation of the vehicle, so driving the DC/DC converter may exhibit excessive performance. In such a case, the power conversion efficiency of the DC/DC converter becomes poor because of low-power power conversion.

### SUMMARY OF INVENTION

The invention provides a power supply system that may be charged by an external power supply and that suppresses a decrease in charging efficiency during external charging, and a vehicle equipped with the power supply system.

A first aspect of the invention relates to a power supply system. The power supply system includes: a first electrical storage device; a charging device that charges the first electrical storage device with electric power supplied from an external power supply; a second electrical storage device that supplies an auxiliary load with a power supply voltage lower than an output voltage of the first electrical storage device; a first converter that steps down a voltage of electric power supplied from the first electrical storage device and that supplies a power supply voltage to the auxiliary load and the second electrical storage device; a first controller that controls the charging device; a second converter that has a capacity smaller than that of the first converter and that uses the electric power supplied from the external power supply to supply the first controller with a power supply voltage and to charge the second electrical storage device; and a second controller that, when electric power is charged from the external power supply, controls the first converter and the second converter so as to selectively operate any one of the first converter and the second converter on the basis of a state of charge of the second electrical storage device and a state of the auxiliary load.

In the power supply system, the first converter may have a characteristic that an operation efficiency of the first converter decreases when an output electric power of the first converter decreases below a reference value, and the second controller may operate the first converter when an electric power higher than the reference value is required.

In the power supply system, when the state of charge of the second electrical storage device is lower than or equal to a first threshold that indicates a lower limit of the state of charge of the second electrical storage device, the second controller may select to stop the second converter and to operate the first converter until the state of charge of the second electrical storage device becomes higher than or equal to a second threshold that is higher than the first threshold, and, when the first converter is not operated, the second controller may select to operate the second converter.

In the power supply system, the state of the auxiliary load may include an electric power consumed by the auxiliary load, and the second controller may select to operate the second converter when the electric power consumed by the auxiliary load is lower than an electric power that can be output by the second converter.

In the power supply system, the second converter may use the electric power from the external power supply to supply the second controller with a power supply voltage, when electric power is charged from the external power supply, the second controller may control the first converter and the second converter so as to selectively operate any one of the first converter and the second converter on the basis of the state of charge of the second electrical storage device and states of the auxiliary load, first controller and second controller, the states of the auxiliary load, first controller and second controller may include an electric power consumed by the auxiliary load, an electric power consumed by the first controller and an electric power consumed by the second controller, and, when the sum of the electric power consumed by the auxiliary load, the electric power consumed by the first controller and the electric power consumed by the second controller is higher than the electric power that can be output by the second converter, the sum of the electric power consumed by the auxiliary load and the electric power consumed by the second controller is lower than the electric power that can be output by the second converter, and the state of charge of the second electrical storage device is lower than or equal to the first threshold that indicates a lower limit of the state of charge of the second electrical storage device, the second controller may select to operate the second converter.

In the power supply system, the second controller may include an estimating unit that estimates the electric power consumed by the auxiliary load on the basis of a usage state and usage schedule of the auxiliary load.

In the power supply system, the second converter may be an AC/DC converter that converts alternating-current electric power supplied from the external power supply to direct-current electric power.

In the power supply system, the charging device may include a rectifier circuit that rectifies alternating-current electric power supplied from the external power supply to direct-current electric power, and the second converter may be a DC/DC converter that converts direct-current voltage rectified by the rectifier circuit.

A second aspect of the invention relates to a vehicle. The vehicle includes: a first electrical storage device; a driving device that generates driving force for propelling the vehicle with electric power supplied from the first electrical storage device; a charging device that charges the first electrical storage device with electric power supplied from an external power supply; an auxiliary load; a second electrical storage device that supplies the auxiliary load with a power supply voltage lower than an output voltage of the first electrical storage device; a first converter that steps down a voltage of electric power supplied from the first electrical storage device and that supplies a power supply voltage to the auxiliary load and the second electrical storage device; a first controller that controls the charging device; a second converter that has a capacity smaller than that of the first converter and that uses the electric power supplied from the external power supply to supply the first controller with a power supply voltage and to charge the second electrical storage device; and a second controller that, when electric power is charged from the external power supply, controls the first converter and the second converter so as to selectively operate any one of the first converter and the second converter on the basis of a state of charge of the second electrical storage device and a state of the auxiliary load.

According to the aspects of the invention, in the vehicle power supply system that is chargeable by an external power supply, it is possible to suppress a decrease in charging efficiency during external charging.

### BRIEF DESCRIPTION OF DRAWINGS

The features, advantages, and technical and industrial significance of this invention will be described below with reference to the accompanying drawings, in which like numerals denote like elements, and wherein:

FIG. 1 is an overall block diagram of a vehicle equipped with a power supply system according to an embodiment of the invention;

FIG. 2 is a view that shows an example of the internal configuration of a PCU according to the embodiment of the invention;

FIG. 3 is a graph that shows an example of the correlation between the output power of a DC/DC converter and the operation efficiency according to the embodiment of the invention;

FIG. 4 is a graph for illustrating the outline of charging control over an auxiliary battery during external charging according to the embodiment of the invention;

FIG. 5 is a functional block diagram for illustrating charging control executed by an HV-ECU over the auxiliary battery during external charging according to the embodiment of the invention;

FIG. 6 is a flowchart for illustrating the detailed charging control process executed by the HV-ECU over the auxiliary battery during external charging according to the embodiment of the invention;

FIG. 7 is an overall block diagram of a vehicle equipped with a power supply system according to an alternative embodiment to the embodiment of the invention; and

FIG. 8 is a view that shows an example of the internal configuration of a rectifier circuit according to the embodiment of the invention.

### DETAILED DESCRIPTION OF EMBODIMENTS

Hereinafter, an embodiment of the invention will be described in detail with reference to the accompanying drawings. Note that like reference numerals denote the same or corresponding components and the description thereof is not repeated.

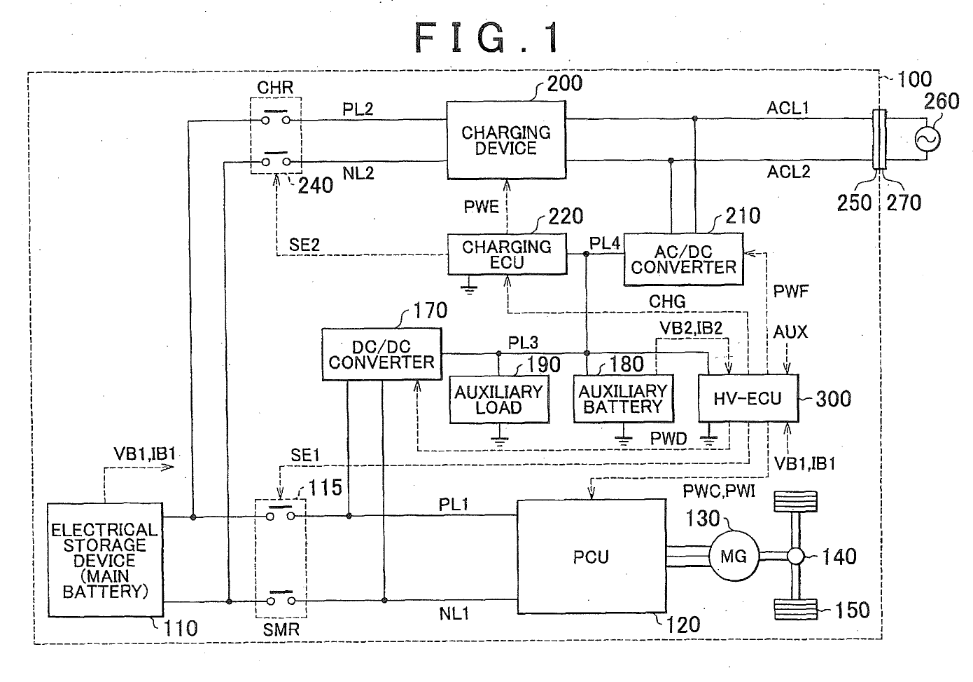

FIG. 1 is an overall block diagram of a vehicle 100 equipped with a power supply system according to the embodiment of the invention.

As shown in FIG. 1, the vehicle 100 includes an electrical storage device 110, a system main relay (hereinafter, also referred to as SMR) 115, a power control unit (PCU) 120 that serves as a driving device, a motor generator 130, a power transmission gear 140, drive wheels 150 and a controller (hereinafter, also referred to as HV-electronic control unit (ECU)) 300.

The electrical storage device 110 is an electric power storage element that is configured to be chargeable and dischargeable. The electrical storage device 110 is, for example, formed of a secondary battery, such as a lithium ion battery, a nickel-metal hydride battery and a lead-acid battery, or an electrical storage element, such as an electric double layer capacitor.

The electrical storage device 110 is connected via the SMR 115 to the PCU 120 for driving the motor generator 130. Then, the electrical storage device 110 supplies the PCU 120 with electric power for generating driving force of the vehicle 100. In addition, the electrical storage device 110 stores electric power generated by the motor generator 130. The output of the electrical storage device 110 is, for example, 200 V.

One ends of relays included in the SMR 115 are respectively connected to the positive electrode terminal and negative electrode terminal of the electrical storage device 110. The other ends of the relays included in the SMR 115 are respectively connected to a power line PL1 and a ground line NL1 that are connected to the PCU 120. Then, the SMR 115 switches between supply and interruption of electric power between the electrical storage device 110 and the PCU 120 on the basis of a control signal SE1 from the HV-ECU 300.

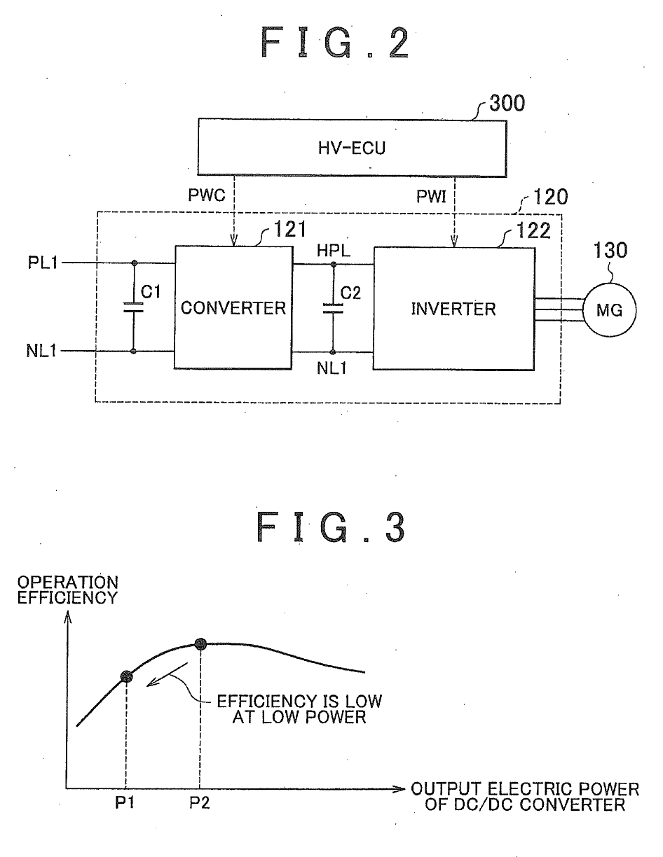

FIG. 2 is a view that shows an example of the internal configuration of the PCU 120. As shown in FIG. 2, the PCU 120 includes a converter 121, an inverter 122, and capacitors C1 and C2.

The converter 121 carries out power conversion between the power line PL1 and the ground line NL1, and a power line HPL and the ground line NL1 on the basis of a control signal PWC from the HV-ECU 300.

The inverter 122 is connected to the power line HPL and the ground line NL1. The inverter 122 converts direct-current electric power supplied from the converter 121 to alternating-current electric power to drive the motor generator 130 on the basis of a control signal PWI from the HV-ECU 300. Note that, in the present embodiment, a pair of the motor generator and the inverter are provided as an example; instead, multiple pairs of the motor generator and the inverter may be provided.

The capacitor C1 is provided between the power line PL1 and the ground line NL1 to reduce fluctuations in voltage between the power line PL1 and the ground line NL1. In addition, the capacitor C2 is provided between the power line HPL and the ground line NL1 to reduce fluctuations in voltage between the power line HPL and the ground line NL1.

Referring back to FIG. 1, the motor generator 130 is an alternating-current rotating electrical machine, and is, for example, a permanent magnet-type synchronous motor that includes a rotor in which a permanent magnet is embedded.

The output torque of the motor generator 130 is transmitted to the drive wheels 150 via the power transmission gear 140 to propel the vehicle 100. The power transmission gear 140 is formed of a reduction gear and a power split mechanism. The motor generator 130 is able to generate electric power using the rotational force of the drive wheels 150 during regenerative braking operation of the vehicle 100. Then, the generated electric power is converted by the PCU 120 to charging electric power to charge the electrical storage device 110.

In addition, in a hybrid vehicle equipped with an engine (not shown) in addition to the motor generator 130, the engine and the motor generator 130 are cooperatively operated to generate required vehicle driving force. In this case, the electrical storage device 110 may be charged with electric power generated from the rotation of the engine.

That is, the vehicle 100 according to the present embodiment is a vehicle equipped with an electric motor for generating vehicle driving force. The vehicle 100 includes a hybrid vehicle, an electric vehicle, a fuel cell vehicle, and the like. The hybrid vehicle generates vehicle driving force using an engine and an electric motor. The electric vehicle and the fuel cell vehicle are not equipped with an engine.

Portions of the configuration of the vehicle 100 shown in the drawing, excluding the motor generator 130, the power transmission gear 140 and the drive wheels 150, constitute the power supply system of the vehicle.

The power supply system further includes a DC/DC converter 170, an auxiliary battery 180 and an auxiliary load 190 as a configuration of a low-voltage system (auxiliary system).

The DC/DC converter 170 is connected to the power line PL1 and the ground line NL1. The DC/DC converter 170 steps down direct-current voltage supplied from the electrical storage device 110 on the basis of a control signal PWD from the HV-ECU 300. Then, the DC/DC converter 170 supplies electric power to the low-voltage system all over the vehicle, such as the auxiliary battery 180, the auxiliary load 190 and the I-IV-ECU 300, via a power line PL3.

The auxiliary battery 180 is typically formed of a lead-acid battery. The output voltage of the auxiliary battery 180 is lower than the output voltage of the electrical storage device 110, and is, for example, about 12 V.

The auxiliary load 190, for example, includes lamps, a wiper, a heater, an audio, a navigation system, and the like.

The HV-ECU 300 includes a central processing unit (CPU), a storage device and an input/output buffer (all of them are not shown in FIG. 1). The HV-ECU 300 inputs signals from sensors, or the like, and outputs control signals to devices. The HV-ECU 300 controls the vehicle 100 and the devices. Note that these controls are not limited to software processing; they may be processed by exclusive hardware (electronic circuit).

The HV-ECU 300 outputs control signals for controlling the PCU 120, the DC/DC converter 170, the SMR 115, and the like.

The HV-ECU 300 receives a detected voltage VB1 and a detected current IB1 from sensors (not shown) included in the electrical storage device 110. The HV-ECU 300 computes the state of charge SOC1 of the electrical storage device 110 on the basis of the voltage VB1 and the current IB1. In addition, the HV-ECU 300 receives a detected voltage VB2 and/or a detected current IB2 from sensors (not shown) included in the auxiliary battery 180. The HV-ECU 300 computes the state of charge SOC2 of the auxiliary battery 180 on the basis of the voltage VB2 and/or the current IB2.

In addition, the HV-ECU 300 receives a signal AUX that indicates the usage state and usage schedule of the auxiliary load 190. The signal AUX is set on the basis of the usage state resulting from driving signals to the devices included in the auxiliary load 190, electric power used, and the like, and the usage schedules of the devices, input through an input unit (not shown) by a driver. The HV-ECU 300 executes charging control (which will be descried later) on the basis of the SOC2 of the auxiliary battery 180 and the signal AUX relevant to the auxiliary load while the in-vehicle electrical storage device is being charged with a power supply (hereinafter, also simply referred to as “external power supply”) outside the vehicle (hereinafter, also simply referred to as “external charging”).

The power supply system includes a charging device 200, an AC/DC converter 210, a charging ECU 220, a charging relay (CHR) 240 and a connecting portion 250 as a configuration for charging the electrical storage device 110 with electric power supplied from the external power supply 260.

A charging connector 270 of the charging cable is connected to the connecting portion 250. Then, electric power from the external power supply 260 is transmitted to the vehicle 100 via the charging cable.

The charging device 200 is connected to the connecting portion 250 via power lines ACL1 and ACL2. In addition, the charging device 200 is connected to the electrical storage device 110 via the CHR 240. Then, the charging device 200 converts alternating-current electric power supplied from the external power supply 260 to direct-current electric power with which the electrical storage device 110 is chargeable on the basis of a control signal PWE from the charging ECU 220.

One ends of relays included in the CHR 240 are respectively connected to the positive electrode terminal and negative electrode terminal of the electrical storage device 110. The other ends of the relays included in the CHR 240 are respectively connected to the power line PL2 and the ground line NL2 that are connected to the charging device 200. Then, the CHR 240 switches between supply and interruption of electric power between the electrical storage device 110 and the charging device 200 on the basis of a control signal SE2 from the charging ECU 220.

The AC/DC converter 210 is connected to the power lines ACL1 and ACL2. The AC/DC converter 210 is controlled by a control signal PWF from the HV-ECU 300 to convert alternating-current voltage supplied from the external power supply 260 to direct-current voltage. Then, the AC/DC converter 210 supplies power supply voltage to the charging ECU 220 via a power line PL4. In addition, the power line PL4 is also connected to the power line PL3. Then, during external charging, electric power from the AC/DC converter 210 is used to make it possible to charge the auxiliary battery 180 and drive the auxiliary load 190. The AC/DC converter 210 is basically used to supply power supply voltage to the charging ECU 220, so the employed rated output of the AC/DC converter 210 is lower than the rated output of the above described DC/DC converter 170.

The charging ECU 220 is a controller for controlling the charging device 200 and the CHR 240. The charging ECU 220 is configured to be communicable with the HV-ECU 300. The charging ECU 220 controls the charging device 200 and the CHR 240 in accordance with a charging command CHG from the HV-ECU 300 to carry out external charging.

Note that, in FIG. 1, the charging ECU 220 is provided separately from the charging device 200; however, the charging ECU 220 may be included in the charging device 200. Alternatively, the HV-ECU 300 may be configured to include the function of the charging ECU 220.

In the thus configured vehicle 100, during operation of the vehicle, the DC/DC converter 170 is generally constantly operated in order to charge the auxiliary battery 180 and drive the auxiliary load 190.

Even during external charging, the auxiliary load 190 may be operated by the driver; however, an electric power consumed by the auxiliary load 190 in this case is mostly lower than an electric power consumed during operation of the vehicle.

The DC/DC converter 170 having a relatively large capacity as described above is generally employed in order to supply electric power to an auxiliary system during operation of the vehicle. FIG. 3 is a graph that shows an example of the correlation between the output power of the DC/DC converter 170 and the operation efficiency. In such a large-capacity DC/DC converter, as the output power decreases below a certain reference value (for example, point P2 in FIG. 3), the operation efficiency tends to gradually decrease. Therefore, as described above, during external charging in which consumed electric power is lower than that during operation of the vehicle, it is desirable not to operate the DC/DC converter 170 as much as possible.

On the other hand, when the DC/DC converter 170 is not operated, the HV-ECU 300 and the auxiliary load 190 are supplied with power supply voltage from the auxiliary battery 180 in principle. However, as electric power is consumed by the HV-ECU 300 and the auxiliary load 190, the SOC2 of the auxiliary battery 180 gradually decreases. Therefore, it is required to charge the auxiliary battery 180.

Then, in the present embodiment, during external charging, charging control for charging the auxiliary battery 180 by selectively operating the small-capacity AC/DC converter 210 used for the charging ECU 220 and the large-capacity DC/DC converter 170 is executed on the basis of the state of charge of the auxiliary battery 180 and the state of the auxiliary load 190. Through the above control, during external charging, the AC/DC converter 210 is used to charge the auxiliary battery 180 to minimize the frequency of use of the DC/DC converter 170 at a low electric power to thereby suppress a decrease in charging efficiency. Furthermore, when an electric power consumed by the auxiliary load 190 during external charging is high and charging electric power to charge the auxiliary battery 180 cannot be supplied by the AC/DC converter 210, the AC/DC converter 210 is stopped, and driving electric power to drive the auxiliary load 190, charging electric power to charge the auxiliary battery and driving electric power to drive the charging ECU 220 are supplied from the DC/DC converter 170. By so doing, when the DC/DC converter 170 is operated, the output electric power of the DC/DC converter 170 is made higher than a reference output electric power that is used to determine whether the operation efficiency is decreased to thereby suppress a decrease in operation efficiency and, as a result, suppress a decrease in charging efficiency.

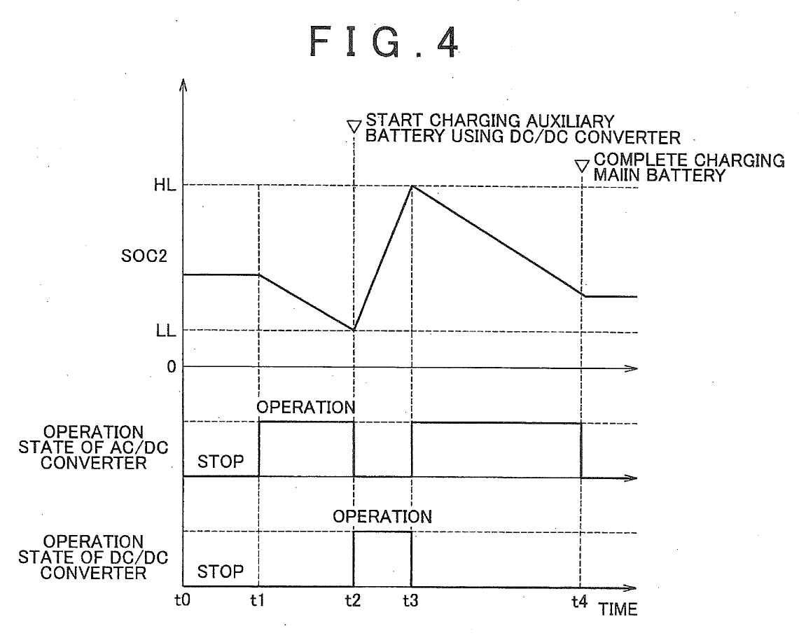

FIG. 4 is a graph for illustrating the outline of charging control over the auxiliary battery during external charging according to the present embodiment. In FIG. 4, the abscissa axis represents time, and the ordinate axis represents the state of charge SOC2 of the auxiliary battery 180, the operation state of the AC/DC converter 210 and the operation state of the DC/DC converter 170.

As shown in FIG. 1 and FIG. 4, between time t0 and time t1, the vehicle 100 is neither operated nor subjected to external charging, both the AC/DC converter 210 and the DC/DC converter 170 are stopped, and the state of charge SOC2 of the auxiliary battery 180 is also constant.

At time t1, the charging connector 270 of the charging cable is connected to the connecting portion 250 of the vehicle 100, the operation of the AC/DC converter 210 is started and the charging of the electrical storage device 110 that is the main battery is started accordingly. At this time, the DC/DC converter 170 is not operated.

In the example of FIG. 4, while the electrical storage device 110 is being charged, electric power output from the AC/DC converter 210 is not sufficient for the overall electric power consumed by the controllers (the FIV-ECU 300 and the charging ECU 220) and the auxiliary load 190, so electric power is also output from the auxiliary battery 180, and the SOC2 of the auxiliary battery 180 decreases with time.

Then, when the state of charge SOC2 has decreased to at or below a lower limit threshold LL that indicates that it is required to charge the auxiliary battery 180 at time t2, the HV-ECU 300 stops the AC/DC converter 210, and starts the operation of the DC/DC converter 170. The DC/DC converter 170 supplies power supply voltage to the HV-ECU 300, the charging ECU 220 and the auxiliary load 190, while the DC/DC converter 170 charges the auxiliary battery 180 until the state of charge SOC2 of the auxiliary battery 180 becomes higher than or equal to the upper limit threshold HL that indicates a full charge (between time t2 and time t3). During then, the charging of the electrical storage device 110 is continued.

At the time point (time t3) when the state of charge SOC2 of the auxiliary battery 180 becomes higher than or equal to the threshold HL, the operation of the DC/DC converter 170 is stopped, and the operation of the AC/DC converter 210 is resumed.

Then, when the charging of the electrical storage device 110 is completed at time t4, the operation of the charging device 200 is stopped, and the AC/DC converter 210 is stopped.

Note that FIG. 4 shows the case where the DC/DC converter 170 is operated only once; however, when the state of charge SOC2 becomes lower than or equal to the threshold LL again before the charging of the electrical storage device 110 is complete after t3 in FIG. 4, the DC/DC converter 170 is operated until the SOC2 becomes higher than or equal to the threshold HL as in the case between time t2 and time t3.

Note that, when electric power output from the AC/DC converter 210 is sufficient for the overall electric power of the controllers (the HV-ECU300 and the charging ECU 220) and the auxiliary load 190, the state of charge SOC2 of the auxiliary battery 180 does not decrease while the electrical storage device 110 is being charged. In this case, the state of charge SOC2 does not become lower than or equal to the threshold LL, so the DC/DC converter 170 is not operated.

In addition, electric power output from the AC/DC converter 210 is not sufficient for the overall electric power of the controllers (the HV-ECU300 and the charging ECU 220) and the auxiliary load 190; however, when the state of charge SOC2 becomes lower than or equal to the threshold LL in the case where electric power output from the AC/DC converter 210 is sufficient for electric power of the HV-ECU 300 and auxiliary load 190, the charging device 200 and the charging ECU 220 may be stopped to interrupt the charging of the electrical storage device 110, and the AC/DC converter 210 may be used to charge the auxiliary battery 180. However, because the charging of the electrical storage device 110 is interrupted and the low-power AC/DC converter 210 is used to charge the auxiliary battery 180, a period of time up to completion of charging of the electrical storage device 110 extends, so there is a possibility that the charging efficiency deteriorates. Therefore, when a period of time up to completion of charging of the electrical storage device 110 remarkably extends, the DC/DC converter 170 may be used to charge the auxiliary battery 180 even when the AC/DC converter 210 is able to supply electric power.

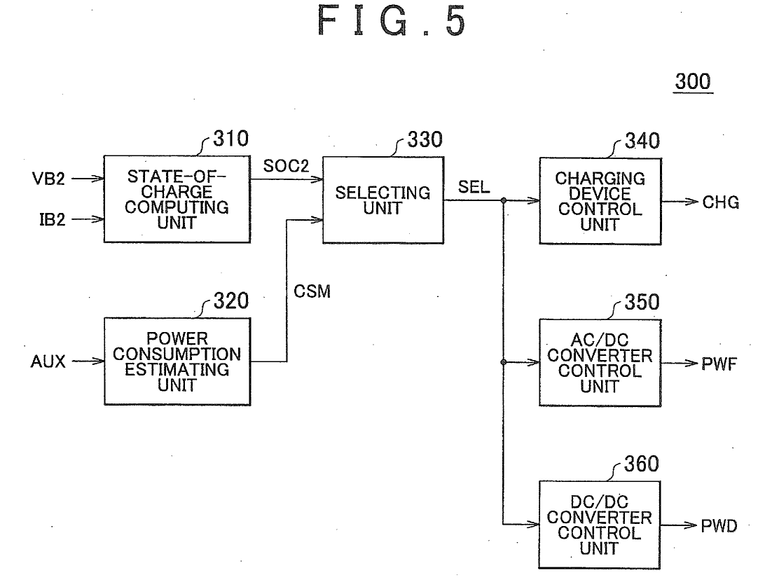

FIG. 5 is a functional block diagram for illustrating charging control executed by the HV-ECU 300 over the auxiliary battery 180 during external charging according to the present embodiment. The functional blocks shown in the functional block diagram of FIG. 5 are implemented through hardware processing or software processing by the HV-ECU 300.

As shown in FIG. 1 and FIG. 5, the HV-ECU 300 includes a state-of-charge computing unit 310, a power consumption estimating unit 320, a selecting unit 330, a charging device control unit 340, an AC/DC converter control unit 350 and a DC/DC converter control unit 360.

The state-of-charge computing unit 310 receives the voltage VB2 and current IB2 of the auxiliary battery 180. The state-of-charge computing unit 310 computes the state of charge SOC2 of the auxiliary battery 180 on the basis of these pieces of information, and outputs the computed SOC2 to the selecting unit 330.

The power consumption estimating unit 320 receives a signal AUX that indicates the usage state and usage schedule of the auxiliary load 190. The power consumption estimating unit 320 uses a map, or the like, prestored in a storage unit (not shown) to estimate an electric power CSM consumed by auxiliaries on the basis of the signal AUX and then outputs the estimated consumed electric power CSM to the selecting unit 330. Note that, in this case, the estimated consumed electric power CSM includes an electric power consumed by the controllers, such as the HV-ECU 300 and the charging ECU 220.

The selecting unit 330 receives the state of charge SOC2 from the state-of-charge computing unit 310 and the estimated consumed electric power CSM from the power consumption estimating unit 320. On the basis of these pieces of information, the selecting unit 330 determines whether the AC/DC converter 210 is operated or the DC/DC converter 170 is operated and whether the charging device 200 is operated. Then, the selecting unit 330 outputs a selection signal SEL that indicates the result of determination to the charging device control unit 340, the AC/DC converter control unit 350 and the DC/DC converter control unit 360.

The charging device control unit 340 receives the selection signal SEL from the selecting unit 330. Then, the charging device control unit 340 generates a charging command CHG, indicating that the charging device 200 is operated or stopped, on the basis of the selection signal SEL, and then outputs the charging command CHG to the charging ECU 220. The charging ECU 220 controls the charging device 200 and the CHR 240 in accordance with the charging command CHG.

The AC/DC converter control unit 350 receives the selection signal SEL from the selecting unit 330. Then, the AC/DC converter control unit 350 generates a control signal PWF for operating the AC/DC converter 210 on the basis of the selection signal SEL, and then outputs the control signal PWF to the AC/DC converter 210.

The DC/DC converter control unit 360 receives the selection signal SEL from the selecting unit 330. Then, the DC/DC converter control unit 360 generates a control signal PWD for operating the DC/DC converter 170 on the basis of the selection signal SEL, and then outputs the control signal PWD to the DC/DC converter 170.

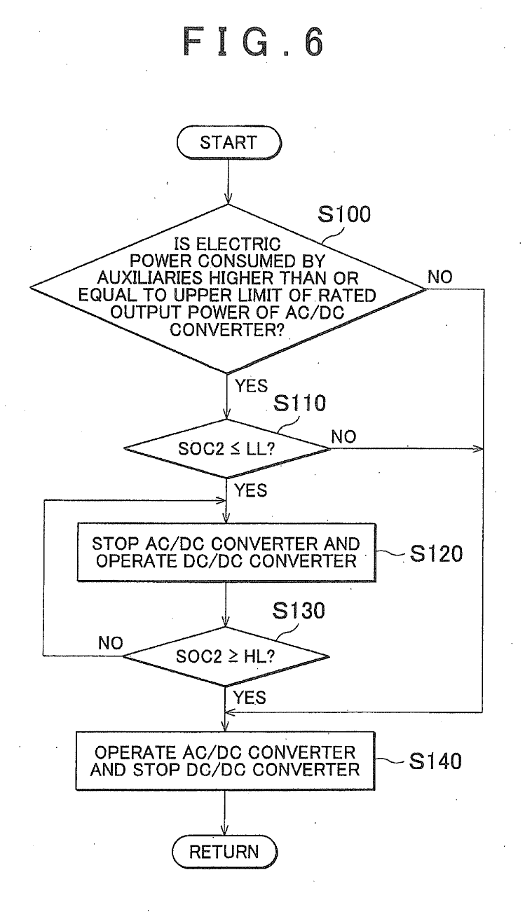

FIG. 6 is a flowchart for illustrating the detailed charging control process executed by the HV-ECU 300 over the auxiliary battery 180 during external charging according to the present embodiment. The process of the flowchart shown in FIG. 6 is implemented in such a manner that a program prestored in the HV-ECU 300 is called from a main routine and is executed at a predetermined interval. Alternatively, the process of part of or all the steps may be implemented by exclusive hardware (electronic circuit).

As shown in FIG. 1 and FIG. 6, when the charging cable is connected to the connecting portion 250 and electric power from the external power supply 260 is used to start external charging, the HV-ECU 300 determines in step (hereinafter, step is abbreviated as S) 100 whether the estimated electric power CSM consumed by the auxiliaries including the controllers is higher than or equal to the upper limit of the rated output power of the AC/DC converter 210.

When the estimated consumed electric power CSM is higher than or equal to the upper limit of the rated output power of the AC/DC converter 210 (YES in S100), the HV-ECU 300 determines that the AC/DC converter 210 is not able to supply the overall electric power of the auxiliaries, and then the process proceeds to S110.

In S110, the HV-ECU 300 determines whether the state of charge SOC2 of the auxiliary battery 180 is lower than or equal to the lower limit threshold LL at or below which the auxiliary battery 180 is required to be charged.

When the state of charge SOC2 is lower than or equal to the threshold LL (YES in S110), the HV-ECU 300 stops the operation of the AC/DC converter 210 and starts the operation of the DC/DC converter 170 in S120. By so doing, electric power from the high-power DC/DC converter 170 is used to charge the auxiliary battery 180.

Then, the HV-ECU 300 determines in S130 whether the state of charge SOC2 is higher than or equal to the upper limit threshold HL that indicates a full charge.

When the state of charge SOC2 is lower than the threshold HL (NO in S130), the HV-ECU 300 determines that the charging of the auxiliary battery 180 is not completed yet, and returns the process to S120 to continue charging the auxiliary battery 180 with electric power from the DC/DC converter 170.

When the state of charge SOC2 is higher than or equal to the threshold HL (YES in S130), the HV-ECU 300 determines that the charging of the auxiliary battery 180 is completed, and then the process proceeds to S140. Then, the HV-ECU 300 stops the operation of the DC/DC converter 170 and resumes the operation of the AC/DC converter 210.

When the estimated consumed electric power CSM is lower than the upper limit of the rated output power of the AC/DC converter 210 (NO in S100) or when the state of charge SOC2 is higher than the threshold LL (NO in S110), the process proceeds to S140, and then the HV-ECU 300 operates the AC/DC converter 210 and stops the DC/DC converter 170.

By executing control in accordance with the above described process, the AC/DC converter 210 and the DC/DC converter 170 may be selectively operated on the basis of the state of charge SOC2 of the auxiliary battery 180 and the state of the auxiliary load during external charging. As a result, the operation of the DC/DC converter 170 may be minimized during external charging, so it is possible to suppress a decrease in charging efficiency during external charging.

In the above described embodiment, electric power is supplied to the charging ECU, the auxiliary battery, and the like, by the AC/DC converter using electric power from the external power supply.

Incidentally, some charging devices for charging the electrical storage device include a rectifier circuit that converts alternating-current voltage supplied from the external power supply to direct-current voltage. In the case of such a charging device, it is also applicable that a DC/DC converter that steps down direct-current voltage converted by the rectifier circuit is used instead of the AC/DC converter.

In the alternative embodiment, an example of a configuration that includes a small-capacity DC/DC converter instead of the AC/DC converter will be described.

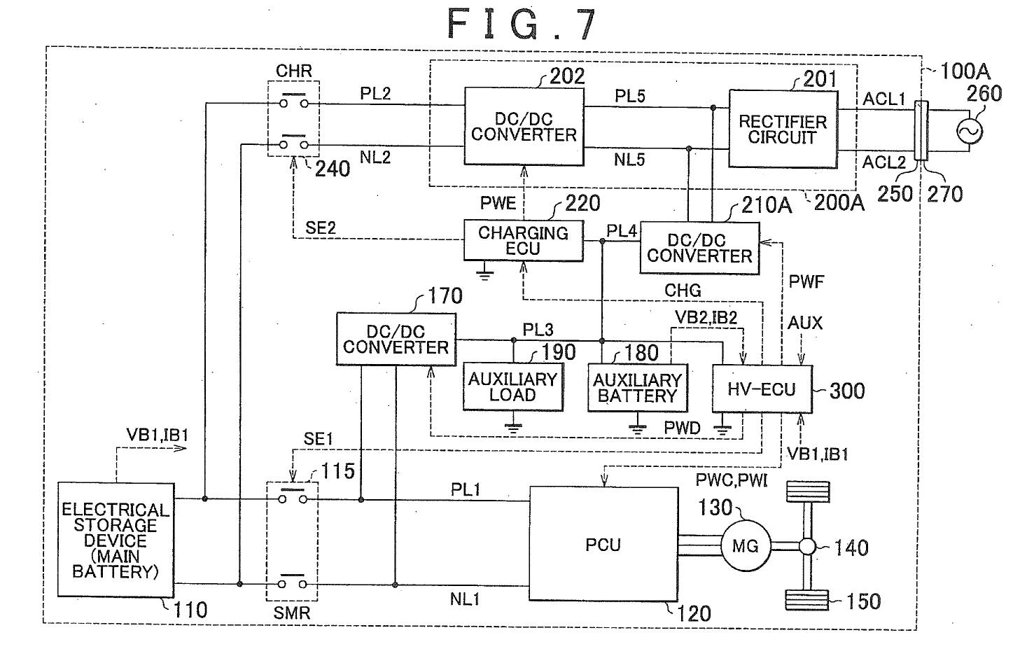

FIG. 7 is an overall block diagram of a vehicle 100A equipped with a power supply system according to the alternative embodiment to the above embodiment. In FIG. 7, the charging device 200 in the configuration shown in FIG. 1 according to the above embodiment is replaced with a charging device 200A, and a small-capacity DC/DC converter 210A is provided instead of the AC/DC converter 210. In FIG. 7, the description of elements that overlap with those in FIG. 1 is not repeated.

As shown in FIG. 7, the charging device 200A includes a rectifier circuit 201 and a DC/DC converter 202. The rectifier circuit 201 is connected to the connecting portion 250 via the power lines ACL1 and ACL2. The rectifier circuit 201 rectifies alternating-current voltage supplied from the external power supply 260 to direct-current voltage, and outputs the direct-current voltage to a power line PL5 and a ground line NL5.

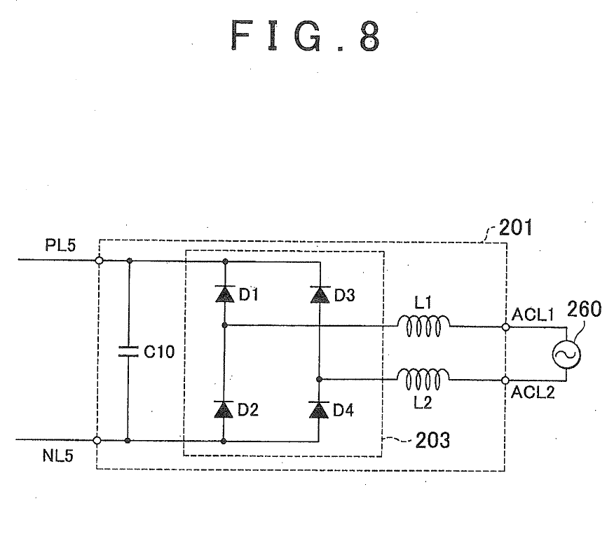

FIG. 8 is a view that shows an example of the internal structure of the rectifier circuit 201. The rectifier circuit 201 includes reactors L1 and L2, a diode bridge 203 and a capacitor C10. The diode bridge 203 includes diodes D1 to D4.

The diode bridge 203 is formed so that the serially-connected diodes D1 and D2 and the serially-connected diodes D3 and D4 are connected to the power line PL5 and the ground line NL5 in parallel with each other.

One end of the reactor L1 is connected to a connection node of the diodes D1 and D2, and the other end of the reactor L1 is connected to the power line ACL1. In addition, one end of the reactor L2 is connected to a connection node of the diodes D3 and D4, and the other end of the reactor L2 is connected to the power line ACL2.

The capacitor C10 is connected between the power line PL5 and the ground line NL5 in parallel with the diode bridge 203, and reduces fluctuations in voltage between the power line PL5 and the ground line NL5.

With the above configuration, the rectifier circuit 201 rectifies alternating-current voltage supplied from the external power supply 260 to direct-current voltage. Note that the configuration of the rectifier circuit 201 is not limited to the configuration shown in FIG. 8 as long as it is a circuit that is able to convert alternating-current voltage to direct-current voltage. As an example of another rectifier circuit, the configuration of the rectifier circuit may be, for example, a full-bridge converter or a half-bridge converter; however, the rectifier circuit is desirably configured as shown in FIG. 8 so as not to require special control to thereby not increase a control load with a simple configuration.

Referring back to FIG. 7, the DC/DC converter 202 is connected to the rectifier circuit 201 via the power line PL5 and the ground line NL5. In addition, the DC/DC converter 202 is connected to the electrical storage device 110 via the CHR 240 by the power line PL2 and the ground line NL2. The DC/DC converter 202 is controlled by the control signal PWE from the charging ECU 220. The DC/DC converter 202 converts direct-current voltage output from the rectifier circuit 201, and supplies charging electric power to the electrical storage device 110.

The DC/DC converter 210A is connected to the power line PL5 and the ground line NL5. The DC/DC converter 210A is controlled by the control signal PWF from the HY-ECU 300. The DC/DC converter 210A steps down direct-current voltage output from the rectifier circuit 201, and outputs the direct-current voltage to the power line PL4.

With the above configuration, by executing the same control as that of the above embodiment, the operation of the high-capacity DC/DC converter 170 is minimized during external charging to thereby make it possible to suppress a decrease in charging efficiency during external charging.

Note that the charging ECU 220 and the HV-ECU 300 according to the above embodiments are respectively an example of a first controller according to the aspect of the invention and an example of a second controller according to the aspect of the invention. The electrical storage device 110 and the auxiliary battery 180 according to the above embodiments are respectively an example of a first electrical storage device according to the aspect of the invention and an example of a second electrical storage device according to the aspect of the invention. The DC/DC converter 170 according to the above embodiments is an example of a first converter according to the aspect of the invention. The AC/DC converter 210 and the DC/DC converter 210A according to the above embodiments each are an example of a second converter according to the aspect of the invention.

The embodiments described above are illustrative and not restrictive in all respects. The scope of the invention is defined by the appended claims rather than the above description. The scope of the invention is intended to encompass all modifications within the scope of the appended claims and equivalents thereof.

1. A power supply system comprising:
a first electrical storage device;
a charging device that charges the first electrical storage device with electric power supplied from an external power supply;
a second electrical storage device that supplies an auxiliary load with a power supply voltage lower than an output voltage of the first electrical storage device;
a first converter that steps down a voltage of electric power supplied from the first electrical storage device and that supplies a power supply voltage to the auxiliary load and the second electrical storage device;
a first controller that controls the charging device;
a second converter that has a capacity smaller than that of the first converter and that uses the electric power supplied from the external power supply to supply the first controller with a power supply voltage and to charge the second electrical storage device; and
a second controller that, when electric power is charged from the external power supply, controls the first converter and the second converter so as to selectively operate any one of the first converter and the second converter on the basis of a state of charge of the second electrical storage device and a state of the auxiliary load.

2. The power supply system according to claim 1, wherein
the first converter has a characteristic that an operation efficiency of the first converter decreases when an output electric power of the first converter decreases below a reference value, and the second controller operates the first converter when an electric power higher than the reference value is required.

3. The power supply system according to claim 2, wherein
when the state of charge of the second electrical storage device is lower than or equal to a first threshold that indicates a lower limit of the state of charge of the second electrical storage device, the second controller selects to stop the second converter and to operate the first converter until the state of charge of the second electrical storage device becomes higher than or equal to a second threshold that is higher than the first threshold, and, when the first converter is not operated, the second controller selects to operate the second converter.

4. The power supply system according to claim 1, wherein
the state of the auxiliary load includes an electric power consumed by the auxiliary load, and the second controller selects to operate the second converter when the electric power consumed by the auxiliary load is lower than an electric power that can be output by the second converter.

5. The power supply system according to claim 1, wherein
the second converter uses the electric power from the external power supply to supply the second controller with a power supply voltage,
when electric power is charged from the external power supply, the second controller controls the first converter and the second converter so as to selectively operate any one of the first converter and the second converter on the basis of the state of charge of the second electrical storage device and states of the auxiliary load, first controller and second controller,
the states of the auxiliary load, first controller and second controller include an electric power consumed by the auxiliary load, an electric power consumed by the first controller and an electric power consumed by the second controller, and
when the sum of the electric power consumed by the auxiliary load, the electric power consumed by the first controller and the electric power consumed by the second controller is higher than the electric power that can be output by the second converter, the sum of the electric power consumed by the auxiliary load and the electric power consumed by the second controller is lower than the electric power that can be output by the second converter, and the state of charge of the second electrical storage device is lower than or equal to the first threshold that indicates a lower limit of the state of charge of the second electrical storage device, the second controller selects to operate the second converter.

6. The power supply system according to claim 4, wherein
the second controller includes an estimating unit that estimates the electric power consumed by the auxiliary load on the basis of a usage state and usage schedule of the auxiliary load.

7. The power supply system according to claim 1, wherein
the second converter is an AC/DC converter that converts alternating-current electric power supplied from the external power supply to direct-current electric power.

8. The power supply system according to claim 1, wherein
the charging device includes a rectifier circuit that rectifies alternating-current electric power supplied from the external power supply to direct-current electric power, and the second converter is a DC/DC converter that converts direct-current voltage rectified by the rectifier circuit.

9. A vehicle comprising:
a first electrical storage device;
a driving device that generates driving force propelling the vehicle with electric power supplied from the first electrical storage device;
a charging device that charges the first electrical storage device with electric power supplied from an external power supply;
an auxiliary load;
a second electrical storage device that supplies the auxiliary load with a power supply voltage lower than an output voltage of the first electrical storage device;
a first converter that steps down a voltage of electric power supplied from the first electrical storage device and that supplies a power supply voltage to the auxiliary load and the second electrical storage device;
a first controller that controls the charging device;
a second converter that has a capacity smaller than that of the first converter and that uses the electric power supplied from the external power supply to supply the first controller with a power supply voltage and to charge the second electrical storage device; and
a second controller that, when electric power is charged from the external power supply, controls the first converter and the second converter so as to selectively operate any one of the first converter and the second converter on the basis of a state of charge of the second electrical storage device and a state of the auxiliary load.
